(19) United States
(12) Patent Application Publication
(10) Pub. No.: US 2011/0044083 A1
(43) Pub. Date: Feb. 24, 2011

(54) Adaptive Photovoltaic Inverter

(76) Inventor: Christopher Thompson, Narragansett, RI (US)

Correspondence Address: STEPTOE & JOHNSON LLP, 1330 CONNECTICUT AVENUE, N.W., WASHINGTON, DC, 20036, US

(21) Appl. No.: 12/722,096

(22) Filed: Mar. 11, 2010

Related U.S. Application Data
(60) Provisional application No. 61/235,526, filed on Aug. 20, 2009.

(51) Int. Cl. H02M 7/537

(52) U.S. Cl. 363/131

(57) ABSTRACT

A DC to AC inverter unit used in a solar cell power system can include a controller capable of adjusting the inverter's minimal operating voltage to increase the inverter unit power capacity.

### CLAIM FOR PRIORITY

This application claims priority under 35 U.S.C. §119(e) to Provisional U.S. Patent Application Ser. No. 61/235,526 filed on Aug. 20, 2009, which is hereby incorporated by reference.

### TECHNICAL FIELD

This invention relates to a DC to AC inverter used in a solar module power system having improved design for adjusting its operating parameters to process more power and have increased power capacity.

### BACKGROUND

A solar module-based power system uses an inverter to convert direct current (DC) from a photovoltaic array into alternating current (AC) for use with home appliances or possibly a utility grid. Inverters have fixed operating parameters that define how the inverter operates. Photovoltaic panels age over time reducing the panels' output voltage and power.

### DESCRIPTION OF DRAWINGS

FIG. 1 is a block diagram illustrating the connection of parts in the solar power system including a DC to AC inverter unit.

FIG. 2 is a flow chart of the voltage control process used in the DC to AC inverter unit shown in FIG. 1.

FIG. 3 is a schematic block diagram of a solar cell power system including a DC to AC inverter unit.

FIG. 4 is a schematic block diagram of a solar cell power system including a DC to AC inverter unit.

### DETAILED DESCRIPTION

An inverter can be used in a solar module-based power system to convert direct current (DC) from a photovoltaic array into alternating current (AC) for use with home appliances or an alternating-current utility grid. Currently, all inverters on the market have fixed operating parameters that define how the inverter operates. However, photovoltaic panels age over time in practice and the ideal operating parameters of the inverter should change accordingly. In particular, thin-film panels have more substantial aging attributes and can degrade as much as 1% or more per year depending on technology. Present state of the art inverters do not compensate for this and consequently are more expensive per Watt than is necessary. A DC to AC inverter unit having improved design for a solar cell power system is described. With adjusting its operational parameters over the life time of photovoltaic panels, better power capacity can be achieved.

In one aspect, a DC to AC inverter unit can include a DC to AC inverter including a minimum operating voltage setting, above which the inverter converts DC power to AC power and an input voltage sensor configured to monitor variation in the input voltage. The DC to AC inverter unit can include an inverter controller configured to adjust the minimum operating voltage setting based on the variation in the input voltage to increase the inverter unit power capacity. The DC to AC inverter unit can include a power switch. The switch can switch back and forth to allow current to flow in two alternate directions. The DC to AC inverter unit can include an output transformer electrically connected to the switch. The inverter controller can include a voltage detection module, which can adjust the output of the transformer and can change the inverter's minimal operating voltage. The adjustment can be made manually or automatically. The adjustment to the output of the transformer can result in from about 2 percent to about 4 percent change to the inverter's minimal operating voltage value. The adjustment to the output of the transformer can result in less than 5 percent change to the inverter's minimal operating voltage value. The adjustment to the output of the transformer can result in less than 10 percent change to the inverter's minimal operating voltage value.

The inverter controller can include a software control module which can read the input voltage value from the input voltage sensor and adjusting the operating parameters of the inverter when it is necessary. The adjustment can result in less than 10 percent change to the inverter's minimal operating voltage value. The inverter controller can include a programmable logic control module reading the input voltage value from the input voltage sensor and sending commands to adjust the operating parameters of the inverter when it is necessary. The commands can result in less than 10 percent change to the inverter's minimal operating voltage value. The DC to AC inverter unit can include a DC input from a solar module to the DC to AC inverter. The DC to AC inverter unit can include a supervisory control and data acquisition system. The supervisory control and data acquisition system can include a sensor acquiring data on the DC input from the solar module, a control unit, a computer supervisory system acquiring data from the sensor and sending commands to the current/voltage control unit, a remote terminal unit connecting to the sensor, converting sensor signals to digital data and sending digital data to the computer supervisory system, a human-machine interface connecting to the remote terminal unit, and a communication infrastructure connecting the computer supervisory system to the remote terminal unit.

In one aspect, a photovoltaic module-based power system can include a photovoltaic array and a DC to AC inverter unit electrically connected to the photovoltaic array including a DC to AC inverter including a minimum operating voltage setting, above which the inverter converts DC power to AC power. The power system can include an input voltage sensor configured to monitor variation in the input voltage. The power system can include an inverter controller configured to adjust the minimum operating voltage setting based on the variation in the input voltage to increase the inverter unit power capacity. The photovoltaic module-based power system can include a power switch. The switch can switch back and forth to allow current to flow in two alternate directions. The photovoltaic module-based power system can include an output transformer electrically connected to the switch. The inverter controller can include a control module making adjustment to the output of the transformer to change the inverter's minimal operating voltage. The adjustment to the output of the transformer can result in less than 10 percent change to the inverter's minimal operating voltage value.

The inverter controller can include a software control module reading the input voltage value from the input voltage sensor and sending commands to the control module. The commands can result in less than 10 percent change to the inverter's minimal operating voltage value. The inverter controller can include a programmable logic control module reading the input voltage value from the input voltage sensor and sending commands to the control module. The commands can result in less than 10 percent change to the inverter's minimal operating voltage value. The photovoltaic module-based power system can include a DC input from a solar module to the DC to AC inverter. The photovoltaic module-based power system can include a supervisory control and data acquisition system, wherein the supervisory control and data acquisition system can include a sensor acquiring data on the DC input from the solar cell power system, a current/voltage control unit, a computer supervisory system acquiring data from the sensor and sending commands to the current/voltage control unit, a remote terminal unit connecting to the sensor, converting sensor signals to digital data and sending digital data to the computer supervisory system, a human-machine interface connecting to the remote terminal unit, and a communication infrastructure connecting the computer supervisory system to the remote terminal unit. The photovoltaic module-based power system can include a heavy-duty safety disconnect switch electrically connected to the inverter. The photovoltaic module-based power system can include a ground fault detection and interruption circuit adjacent to the inverter.

In one aspect, a method to build a photovoltaic module-based power system can include electrically connecting plurality of photovoltaic modules to form a photovoltaic array and electrically connecting a DC to AC inverter unit to the photovoltaic array, wherein the DC to AC inverter unit can include a DC to AC inverter including a minimum operating voltage setting, above which the inverter converts DC power to AC power, an input voltage sensor configured to monitor variation in the input voltage, and an inverter controller configured to adjust the minimum operating voltage setting based on the variation in the input voltage to increase the inverter unit power capacity. The DC to AC inverter can include a power switch, wherein the switch switches back and forth to allow current to flow in two alternate directions. The DC to AC inverter can include an output transformer electrically connected to the switch. The inverter controller can include a control module making adjustment to the output of the transformer to change the inverter's minimal operating voltage. The adjustment to the output of the transformer can result in less than 10 percent change to the inverter's minimal operating voltage value.

The inverter controller can include a software control module reading the input voltage value from the input voltage sensor and sending commands to the control module. The commands can result in less than 10 percent change to the inverter's minimal operating voltage value. The inverter controller can include a programmable logic control module reading the input voltage value from the input voltage sensor and sending commands to the control module. The commands can result in less than 10 percent change to the inverter's minimal operating voltage value. The DC to AC inverter unit can include a DC input from a solar module to the DC to AC inverter. The DC to AC inverter unit can include a supervisory control and data acquisition system, wherein the supervisory control and data acquisition system can include a sensor acquiring data on the DC input from the solar cell power system, a current/voltage control unit, a computer supervisory system acquiring data from the sensor and sending commands to the current/voltage control unit, a remote terminal unit connecting to the sensor, converting sensor signals to digital data and sending digital data to the computer supervisory system, a human-machine interface connecting to the remote terminal unit, and a communication infrastructure connecting the computer supervisory system to the remote terminal unit. The method can include a step of electrically connecting a heavy-duty safety disconnect switch to the inverter. The method can include a step of positioning a ground fault detection and interruption circuit adjacent to the inverter.

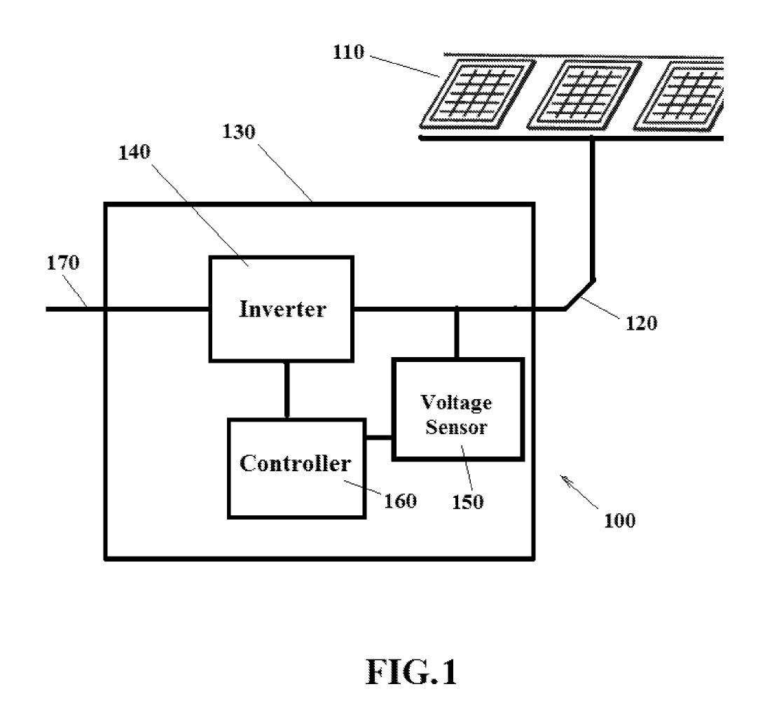

Referring to FIG. 1, solar power system 100 can include photovoltaic or solar array 110. Solar modules 110 can be arranged in any suitable manner, for example, in arrays positioned on the ground or on rooftops. Solar array 110 can include any suitable photovoltaic devices, including thin-film solar devices such as cadmium telluride (CdTe) or Copper Indium Gallium Selenide (CIGS). Alternatively, the photovoltaic devices can be crystalline silicon solar devices or any other suitable photovoltaic devices capable of generating direct current electricity. DC electric current generated by photovoltaic array 110 can output to DC to AC inverter unit 130 by cable 120. DC to AC inverter unit 130 can include DC to AC inverter 140, input voltage sensor 150, and controller 160. DC to AC inverter 140 converts DC input power from photovoltaic array 110 to AC output power. Input voltage sensor 150 monitoring the input voltage variation. Controller 160 receives the input voltage value from input voltage sensor 150 and adjusts the inverter's minimal operating voltage accordingly to process more power and increase the inverter unit power capacity. DC to AC inverter unit 130 can output power to AC power line 170.

Inverters can process more power when operating at a higher voltage but the same inverters are sized with substantial voltage margin to accommodate for aging panels. By having DC to AC inverter unit 130 that adjusts its minimal operating voltage over time, inverters with this technology could process significantly more power and continuously derate at the same rate as the panels. For example, inverters are typically sized for a minimum voltage of 450V, but if their minimum voltage were 540V, the same inverter could process 20% more power. This same inverter could then lower the minimum voltage to 450V over a ten year period.

Solar power system 100 can include supervisory control and data acquisition (SCADA) system or other remote control module, wherein supervisory control and data acquisition (SCADA) system or other remote control module can include at least one sensor acquiring data on the outputs of the solar cell power system, a current/voltage control unit, a computer supervisory system acquiring data from the sensor and sending commands to the current/voltage control unit, a remote terminal unit (RTU) connecting to the sensor in the process, converting sensor signals to digital data and sending digital data to the supervisory system, and a human-machine interface connecting to the remote terminal unit. Solar power system 100 can further include a ground fault circuit interrupter (GFCI).

Photovoltaic inverters with controller/sensor module can include different functions, such as power conversion from DC to AC and Maximum Power Point Tracking (MPPT). The goal of the MPPT algorithm is to extract the greatest power available from the solar array. The power output can be increased with the better MPPT algorithm. With the inverter, the MPPT can be performed on the solar array as an aggregate. The controller/sensor module can adjust its MPPT algorithm over the life time of photovoltaic panels to achieve better power capacity.

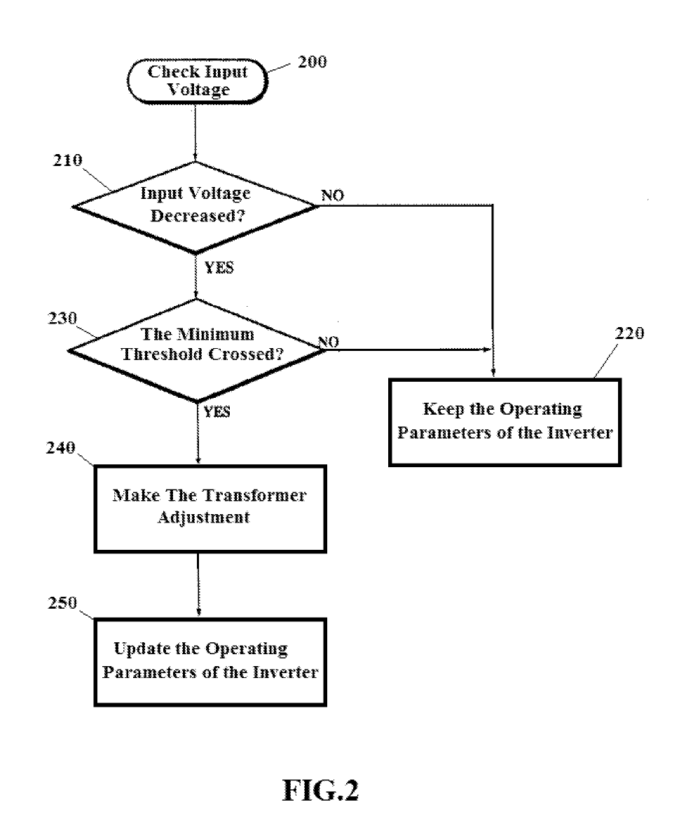

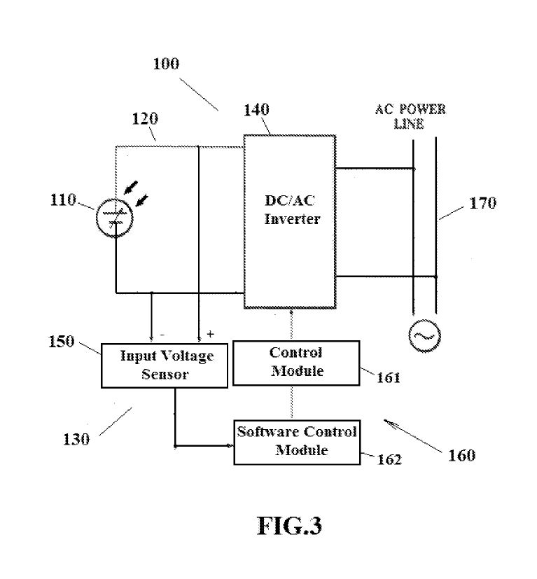

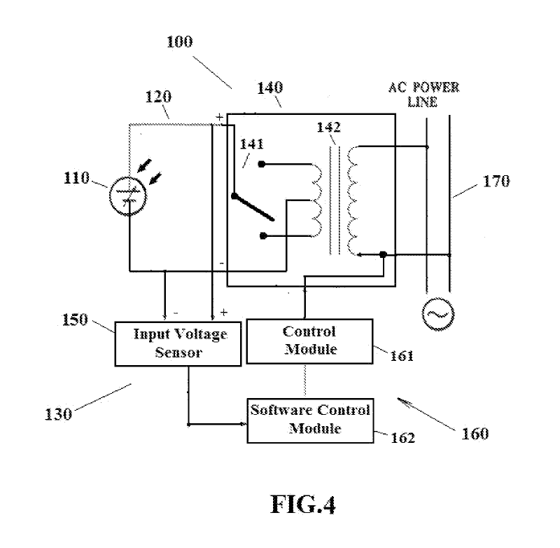

Referring to FIG. 2, in practice, inverter unit 130 uses software control module (162 in FIGS. 3 and 4) to adjust the inverter's operating parameters, such as minimal operating voltage. Inverter unit 130 could continually monitor the input voltage and when this voltage crossed a certain minimum threshold, inverter unit 130 could annunciate that it was now necessary to make the transformer adjustment and update the operating parameters of the inverter. At step 200, the input voltage is checked. If the input voltage is decreased at step 210 (YES) and a preset minimum threshold is crossed at step 230 (YES), an adjustment can be made to the output transformer (142 in FIG. 4) at step 240. The operating parameters of inverter 140 can be updated at step 250. The adjusted operating parameters can include the turn-on voltage or the MPPT start point. The adjustments of operating parameters can also include the MPPT tracking algorithm. In addition, the inverter controls can be reset to recognize that the unit has 2.5% (or more) decreased power capacity. The power handling capacity of the inverter can be reduced with lower operating voltage. The current capacity of the inverter can be fixed. The controller can also be pre-programmed to enable a future switch to the updated operating mode. To the contrary, if input voltage is not decreased at step 210 (NO) or the preset minimum threshold is not crossed at step 230 (NO), no adjustment can be made to the output transformer and the operating parameter of inverter 140 can be kept at step 220. In certain embodiment, transformer adjustments are typically 2.5% each, so this software adjustment could also be 2.5% as well. Transformer adjustments can also be 5%, 10%, or 15%. This technology is applicable to all panel types but thin-film technologies often experience this to the greatest extent.

Referring to FIG. 3, solar power system 100 can include photovoltaic or solar array 110. DC electric current generated by photovoltaic array 110 can output to DC to AC inverter unit 130 by cable 120. DC to AC inverter unit 130 can include DC to AC inverter 140, input voltage sensor 150, and controller 160. DC to AC inverter 140 converts DC input power from photovoltaic array 110 to AC output power. Input voltage sensor 150 monitoring the input voltage variation. Controller 160 receives the input voltage value from input voltage sensor 150 and adjusts the inverter's minimal operating voltage accordingly to process more power and increase the inverter unit power capacity. DC to AC inverter unit 130 can output power to AC power line 170. Controller 160 can include control module 161 making adjustment to output transformer (142 in FIG. 4) to change the inverter's minimal operating voltage. The adjustment to the output transformer can result in a change to the inverter's minimal operating voltage value in a step size about 2.5 percent. Controller 160 can include software control module 162 reading the input voltage value from input voltage sensor 150. Software control module 162 can use the decision making process (flow chart shown in FIG. 3) to determine if commands should be sent to the control module to adjust the inverter's minimal operating voltage. The commands can result in a change to the inverter's minimal operating voltage value in a step size about 2.5 percent. The commands can also result in about 5, 10, or 15 percent change to the inverter's minimal operating voltage value. In certain embodiment, controller 160 can include a programmable logic control module reading the input voltage value from input voltage sensor 150 and sending commands to control module 161. In certain embodiment, solar power system 100 can further include supervisory control and data acquisition (SCADA) system or other remote control module.

Referring to FIG. 4 as an illustration including a simplified inverter circuit, DC to AC inverter 140 can include power switch 141. DC to AC inverter 140 can include output transformer 142 electrically connected to the switch. Switch 141 can be rapidly switched back and forth to allow current to flow back following two alternate paths through one end of the primary winding and then the other. The alternation of the direction of current in transformer 142 produces AC in the output of inverter 140. Controller 160 can include control module 161 making adjustment to output transformer 142 to change the inverter's minimal operating voltage. Power switch 141 can be electromechanical switch, transistor switch, or any other suitable types of semiconductor switches. DC to AC inverter 140 can include any other suitable types of power circuit topologies and control strategies.

A number of embodiments of the invention have been described. Nevertheless, it will be understood that various modifications may be made without departing from the spirit and scope of the invention. It should also be understood that the appended drawings are not necessarily to scale, presenting a somewhat simplified representation of various preferred features illustrative of the basic principles of the invention.

What is claimed is:

1. A DC to AC inverter unit comprising:
a DC to AC inverter including a minimum operating voltage setting, above which the inverter converts DC power to AC power; and
an input voltage sensor configured to monitor variation in the input voltage.

2. The DC to AC inverter unit of claim 1, further comprising an inverter controller configured to adjust the minimum operating voltage setting based on the variation in the input voltage to increase the inverter unit power capacity.

3. The DC to AC inverter unit of claim 1, further comprising a power switch, wherein the switch switches back and forth to allow current to flow in two alternate directions.

4. The DC to AC inverter unit of claim 3, further comprising an output transformer electrically connected to the switch.

5. The DC to AC inverter unit of claim 4, wherein the inverter controller comprises a voltage detection module capable of adjusting the output of the transformer and changing the inverter's minimal operating voltage, wherein the adjustment can be made manually or automatically.

6. The DC to AC inverter unit of claim 5, wherein the adjustment to the output of the transformer can result in from about 2 percent to about 4 percent change to the inverter's minimal operating voltage value.

7. The DC to AC inverter unit of claim 5, wherein the adjustment to the output of the transformer can result in less than 5 percent change to the inverter's minimal operating voltage value.

8. The DC to AC inverter unit of claim 5, wherein the adjustment to the output of the transformer can result in less than 10 percent change to the inverter's minimal operating voltage value.

9. The DC to AC inverter unit of claim 5, wherein the inverter controller comprises a software control module reading the input voltage value from the input voltage sensor and adjusting the operating parameters of the inverter when it is necessary.

10. The DC to AC inverter unit of claim 9, wherein the adjustment can result in a change to the inverter's minimal operating voltage value in a step size about 2.5 percent.

11. The DC to AC inverter unit of claim 5, wherein the inverter controller comprises a programmable logic control module reading the input voltage value from the input voltage sensor and sending commands to adjust the operating parameters of the inverter when it is necessary.

12. The DC to AC inverter unit of claim 11, wherein the commands can result in a change to the inverter's minimal operating voltage value in a step size about 2.5 percent.

13. The DC to AC inverter unit of claim 1, further comprising a DC input from a solar module to the DC to AC inverter.

14. The DC to AC inverter unit of claim 13, further comprising a supervisory control and data acquisition system, wherein the supervisory control and data acquisition system comprises:
a sensor acquiring data on the DC input from the solar module;
a control unit;
a computer supervisory system acquiring data from the sensor and sending commands to the current/voltage control unit;
a remote terminal unit connecting to the sensor, converting sensor signals to digital data and sending digital data to the computer supervisory system;
a human-machine interface connecting to the remote terminal unit; and
a communication infrastructure connecting the computer supervisory system to the remote terminal unit.

15. A photovoltaic module-based power system comprising:
a photovoltaic array; and
a DC to AC inverter unit electrically connected to the photovoltaic array comprising:
a DC to AC inverter including a minimum operating voltage setting, above which the inverter converts DC power to AC power;
an input voltage sensor configured to monitor variation in the input voltage; and
an inverter controller configured to adjust the minimum operating voltage setting based on the variation in the input voltage to increase the inverter unit power capacity.

16. The photovoltaic module-based power system of claim 15, further comprising a power switch, wherein the switch switches back and forth to allow current to flow in two alternate directions.

17. The photovoltaic module-based power system of claim 16, further comprising an output transformer electrically connected to the switch.

18. The photovoltaic module-based power system of claim 17, wherein the inverter controller comprises a control module making adjustment to the output of the transformer to change the inverter's minimal operating voltage.

19. The photovoltaic module-based power system of claim 18, wherein the adjustment to the output of the transformer can result in less than 10 percent change to the inverter's minimal operating voltage value.

20. The photovoltaic module-based power system of claim 17, wherein the inverter controller comprises a software control module reading the input voltage value from the input voltage sensor and sending commands to the control module.

21. The photovoltaic module-based power system of claim 15, further comprising a supervisory control and data acquisition system, wherein the supervisory control and data acquisition system comprises:
a sensor acquiring data on the DC input from the solar cell power system;
a current/voltage control unit;
a computer supervisory system acquiring data from the sensor and sending commands to the current/voltage control unit;
a remote terminal unit connecting to the sensor, converting sensor signals to digital data and sending digital data to the computer supervisory system;
a human-machine interface connecting to the remote terminal unit; and
a communication infrastructure connecting the computer supervisory system to the remote terminal unit.

22. A method to build a photovoltaic module-based power system, comprising:
electrically connecting plurality of photovoltaic modules to form a photovoltaic array; and
electrically connecting a DC to AC inverter unit to the photovoltaic array, wherein the DC to AC inverter unit comprises:
a DC to AC inverter including a minimum operating voltage setting, above which the inverter converts DC power to AC power;
an input voltage sensor configured to monitor variation in the input voltage; and
an inverter controller configured to adjust the minimum operating voltage setting based on the variation in the input voltage to increase the inverter unit power capacity.

23. The method of claim 22, wherein the DC to AC inverter unit comprises a supervisory control and data acquisition system, wherein the supervisory control and data acquisition system comprises:
a sensor acquiring data on the DC input from the solar cell power system;
a control unit;
a computer supervisory system acquiring data from the sensor and sending commands to the control unit;
a remote terminal unit connecting to the sensor, converting sensor signals to digital data and sending digital data to the computer supervisory system;
a human-machine interface connecting to the remote terminal unit; and
a communication infrastructure connecting the computer supervisory system to the remote terminal unit.
